(19) United States
(12) Patent Application Publication
(10) Pub. No.: US 2006/0171546 A1
(43) Pub. Date: Aug. 3, 2006

(54) Device for measuring the sound insulation or insertion of a test object, particularly a passenger compartment section of a motor vehicle

(76) Inventor: Ralph Bungenberg, Dusseldorf (DE)

Correspondence Address: WILLIAM COLLARD;COLLARD & ROE, P.C., 1077 NORTHERN BOULEVARD, ROSLYN, NY, 11576, US

(21) Appl. No.: 11/345,102

(22) Filed: Jan. 31, 2006

(30) Foreign Application Priority Data
Jan. 31, 2005 (DE) 10 2005 004 482.4

(51) Int. Cl. H04B 1/00

(52) U.S. Cl. 381/86; 381/56; 381/122

(57) ABSTRACT

The invention relates to a device for measuring the sound insulation or insertion insulation of a test object, particularly a passenger compartment section of a motor vehicle, wherein said device comprises at least one source of sound, at least one microphone and a device for recording acoustic measuring data. In order to generate a largely homogenous sound field in a sound-absorbing environment, e.g., the interior of a motor vehicle, by means of such a device for the purpose of technical measurements, the invention proposes that the source of sound is formed by a single portable loudspeaker or compression driver (1) that is provided with an adapter (3) containing a plurality of sound openings (7) with flexible tubes (8.1, 8.2, 8.3, 8.n) connected thereto, wherein the open ends (9) of the tubes (8.1, 8.2, 8.3, 8.n) define a plurality of separate punctiform sources of sound.

The invention relates to a device for measuring the sound insulation or insertion insulation of a test object, particularly a passenger compartment section of a motor vehicle, wherein said device comprises at least one source of sound for generating a sound field, at least one microphone or one sound intensity probe and a device for recording acoustic measuring data.

When measuring the sound insulation or insertion insulation of an acoustically effective structural component, the component in question is usually arranged on a wall opening between a transmission chamber that is equipped with several sources of sound and a reception chamber that is equipped with at least one microphone together with a corresponding test orfice. Such measurements sometimes require a largely homogenous sound field.

In the acoustic testing, in particular, of sound-insulating structural component installed in or on motor vehicle parts, e.g., in car doors, a largely homogenous sound field is routinely required in the interior of the motor vehicle, wherein the sound pressure or the sound intensity outside the vehicle is measured with at least one microphone.

However, it is relatively difficult to generate a homogenous sound field with a location-independent, constant sound level in an environment that counteracts the generation of an ideally diffused sound field. This applies, in particular, to the interiors of motor vehicles that not only contain sound-reflecting surfaces such as, for example, window panes, but also numerous sound-absorbing equipment parts such as, for example, textile seat cushions and textile floor coverings.

In order to also generate a largely homogenous sound field for the purpose of acoustic measurements in a non-“diffuse”environment such as, for example, the interior of a motor vehicle, it is nowadays common practice to utilize at least four separate loudspeakers. Despite these high equipment expenditures, the thusly generated sound field is still not sufficiently homogenous for some acoustic measuring methods.

The present invention is based on the objective of providing a device of the initially cited type that makes it possible to generate a largely homogenous sound field in a sound-absorbing environment in a comparatively cost-efficient fashion.

This objective is attained with a device with the characteristics of claim 1. The device according to the invention is essentially characterized in that the source of sound is formed by a single, non-stationary (mobile) loudspeaker or compression driver that is provided with an adapter containing a plurality of sound openings with flexible tubes connected thereto, wherein the open ends of the tubes define a plurality of separate discrete sources of sound.

A largely homogenous sound field can be generated in a sound-absorbing environment such as, for example, the interior of a motor vehicle with this plurality of discrete sources of sound that is preferably realized with a single compression driver or loudspeaker and a corresponding number of flexible tubes as long as the open ends of the tubes are spatially distributed accordingly. The device according to the invention is also more cost-efficient in comparison with known devices of this type that operate with a plurality of separate loudspeakers, namely because the device according to the invention preferably utilizes only one compression driver or loudspeaker and an adapter with tubes connected thereto and the costs of this arrangement are significantly lower than those of the additional loudspeakers required so far.

However, the scope of the present invention also includes embodiments, in which a corresponding measuring device comprises, if so required, several compression drivers or loudspeakers that are respectively provided with an adapter containing a plurality of sound openings with flexible tubes that are open on their ends connected thereto.

The number of flexible tubes or discrete sources of sound depends, in particular, on the size and the sound-absorbing properties of the measuring environment. For example, a sound pressure measurement on large-surface components such as, for example, entry doors of motor coaches may require more discrete sources of sound for the generation of a largely homogenous sound field than a corresponding sound pressure measurement on comparatively small components such as, for example, the door of a small passenger car.

As many flexible tubes as possible should be connected to the adapter for the compression driver or loudspeaker of the device according to the invention. The adapter preferably contains at least 2 sound openings, particularly at least 10 sound openings with one respective flexible tube connected to each sound opening, wherein the open end of each tube represents one discrete source of sound.

An advantageous embodiment of the device according to the invention is also characterized in that the material and/or the structure of one or more tubes is/are realized such that the surface of the tubes also acts in a sound-radiating fashion during the operation of the compression driver or loudspeaker, respectively. This additionally improves the homogeneity of the sound field being generated.

It would also be conceivable that a sound radiation by the surface (outer side) of the tubes is not desired in certain instances. In this respect, the invention proposes another advantageous embodiment, in which one or more flexible tubes are provided with a sound-absorbing or sound-deadening cover. The cover essentially consists of a second tube that coaxially surrounds the inner tube. In this case, the two tubes preferably define an annular space that is filled with air. The thusly modified tubes represent a double tube.

According to another advantageous embodiment of the inventive device, the tubes can be detachably connected to the sound openings of the adapter. This embodiment makes it possible to quickly and easily exchange the tubes, if so required. In this respect, it is possible to exchange shorter tubes with longer tubes and vice versa. This is occasionally advantageous depending on the respective measuring environment or frequency response.

According to another embodiment of the inventive device, the adapter assigned to the loudspeaker or compression driver is realized in the form of convex capsule, particularly a dome-shaped or hemispherical capsule. The convex capsule may also be realized oval. A correspondingly shaped adapter has a relatively large surface for accommodating the sound openings for connecting the flexible tubes. A thusly shaped adapter also favorably influences the uniform distribution of the sound being generated over the connected tubes. The hollow interior of the adapter is preferably realized as small as possible in this case.

Another advantageous embodiment of the device according to the invention is characterized in that the flexible tubes consist of tubes that can be bent in a dimensionally stable fashion. This can be achieved, in particular, by utilizing flexible tubes with an integrated wire spiral. This significantly simplifies the spatial orientation of the tubes, particularly the spatial orientation of their openings that serve as punctiform sources of sound.

The device according to the invention comprises at least one microphone and/or at least one sound intensity probe.

Other preferred and advantageous embodiments of the device according to the invention are disclosed in the dependent claims.

The invention is described in greater detail below with reference to one embodiment that is illustrated in the figures.

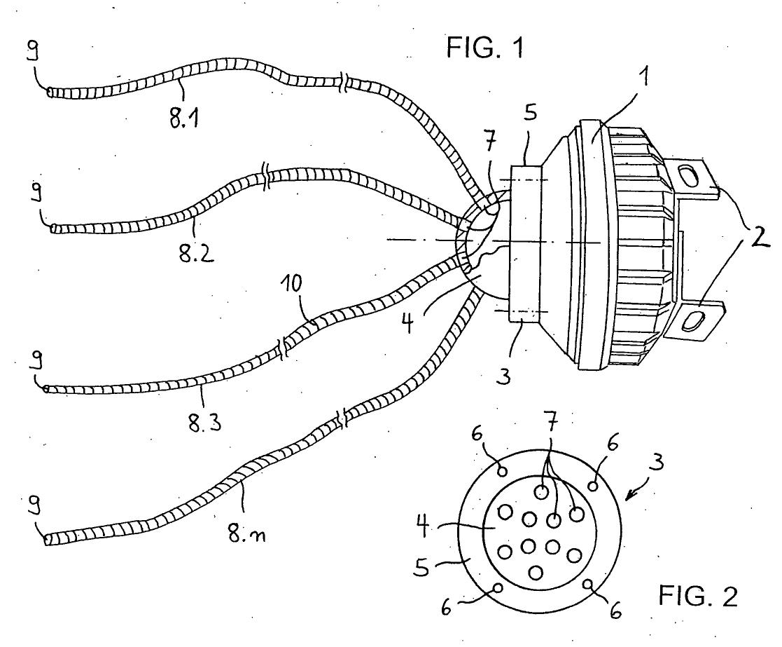

FIG. 1 shows a schematic representation of a single compression driver or loudspeaker with a plurality of flexible tubes connected thereto;

FIG. 2 shows a schematic top view of an adapter for connecting flexible tubes to a compression driver or loudspeaker, and

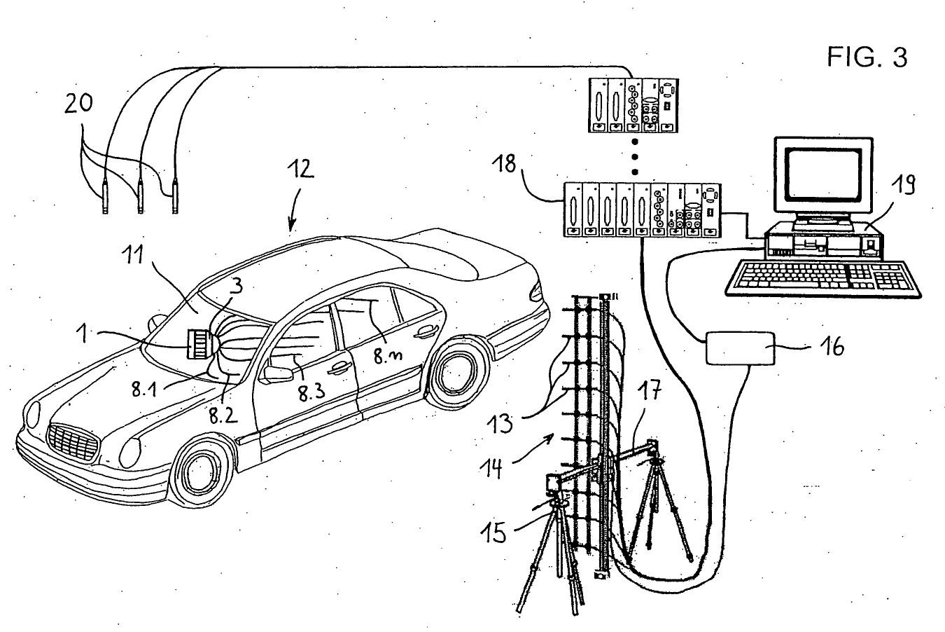

FIG. 3 shows a schematic representation of a measuring arrangement for measuring the sound insulation of sound-insulating built-in parts of a motor vehicle by means of a device according to the invention.

FIG. 1 shows a loudspeaker or compression driver 1, on the housing (chassis) of which angle brackets 2 are arranged in order to mount the compression driver (loudspeaker) 1 on a holding element, e.g. a tripod or a crossbar. An adapter 3 is mounted on the sound exit side of the compression driver or loudspeaker housing such that it completely covers the sound exit opening of the compression driver or loudspeaker 1.

The adapter 3 has a convex capsule section 4 that integrally transforms into a mounting flange 5. The capsule section 4 essentially has the shape of a hollow hemisphere. The flange 5 contains several bores 6 that serve for receiving mounting screws to be screwed to the compression driver or loudspeaker 1. The adapter 3 consists of a metal or plastic part. For example, the adapter is realized in the form of a aluminum part produced by means of a lathe. Alternatively, the adapter 3 may also be realized in the form of an injection-molded plastic part. The capsule-shaped section 4 is illustrated in a partially sectioned fashion in FIG. 1.

Numerous sound openings 7 are arranged in the capsule section 4 of the adapter 3. The sound openings 7 may be realized in the form of bores or in the form of sleeve-like connection pieces (not shown) that protrude from of the outside of the adapter 3. The sound openings 7 are essentially distributed in a uniform fashion over the capsule-shaped section 4 of the adapter 3 (see FIG. 2).

Flexible tubes 8.1, 8.2, 8.3, 8.n are connected to the sound openings 7. The open end 9 of each tube represents a separate discrete source of sound. At least four, preferably at least eight, particularly at least ten tubes are connected to the adapter 3, wherein the open ends 9 of said tubes respectively define separate punctiform sources of sound.

The tubes 8.1, 8.2, 8.3, 8.n can be positively or non-positively inserted into the sound openings 7 of the adapter 3 or positively and non-positively attached to the sleeve-shaped connection pieces (not shown) on the sound openings 7. They can be detachably connected to the adapter 3 in this fashion.

The flexible tubes 8.1, 8.2, 8.3, 8.n are preferably realized such that they can be bent in a dimensionally stable fashion. The tubes consist, in particular, of spiral tubes of plastic or rubber, into the walls of which a wire spiral 10 is cast. The tube material and the tube structure are chosen such that the tube surface acts in a sound-radiating fashion during the operation of the compression driver or loudspeaker 1.

In instances in which a sound radiation by the tube surface is not desired, the tubes 8.1, 8.2, 8.3, 8.n are alternatively realized in a double-walled fashion such that the least sound radiation possible takes place. The inner tube and the outer tube surrounding the inner tube define an annular space that is filled with air in this case.

The inside diameter of the tubes 8.1, 8.2, 8.3, 8.n lies between 3 and 40 mm, preferably between 3 and 25 mm, particularly between 3 and 10 mm. The tubes 8.1, 8.2, 8.3, 8.n have a length between 50 and 500 cm, particularly between 120 and 250 cm.

FIG. 3 shows a measuring arrangement, in which a compression driver or loudspeaker 1 according to FIG. 1 with an adapter 3 and flexible tubes 8.1, 8.2, 8.3, 8.n is utilized. The measuring arrangement serves for measuring the sound insulation on car body sections of a motor vehicle 12. This measuring arrangement also makes it possible, in particular, to realize a so-called STSF-analysis or so-called windowing (SP-measurement)

The STSF-analysis (spatial sound field transformation) is a measuring technology for determining three-dimensional induced sound fields of vibratory structures based on discrete sound pressure measurements with a microphone array or a displaceable microphone bank, respectively. The spatial sound field transformation is based on the known cross spectrum method. One objective of the spatial sound field transformation consists of determining the position of localized partial sources of sound on radiating structure surfaces.

In FIG. 3, the non-stationary or mobile compression driver (loudspeaker) 1 as well as the adapter 3 and the tubes 8.1, 8.2, 8.3, 8.n connected thereto are arranged in the interior 11 of a motor vehicle 12 to be tested.

A largely homogenous sound field is generated in the motor vehicle interior 11 that is realized in a sound-absorbing fashion by means of the compression driver 1 and the tubes 8.1, 8.2, 8.3, 8.n that are connected thereto via the adapter 3 and represent a corresponding number of discrete sources of sound. During the measurement, the tube openings 9 are essentially distributed in a uniform fashion over the interesting region of the motor vehicle interior 11. The tube openings 9 may be arranged linearly in a row or, if applicable, in a two-dimensional or three-dimensional grid.

A plurality of microphones 13 or microphone positions outside the motor vehicle 12 are assigned to the punctiform sources of sound in the motor vehicle interior 11. In the embodiment shown, the microphones 13 are arranged along a line and equidistantly spaced apart from one another. The longitudinal axes of the rod-shaped microphones 13 essentially extend parallel to one another.

Instead of the microphone bank 14 shown, a microphone array may be alternatively utilized for the sound pressure measurement, wherein said microphone array is composed of several microphones 13 that are arranged in a grid.

The microphone bank 14 or the microphone array is respectively mounted on a holding arrangement 15 in a displaceable fashion. The referenced symbol 16 denotes a control device for controlling the movement of the microphone bank 14 along a crossbar 17 of the holding arrangement 15.

The microphone bank 14 or the microphone array is respectively connected to a device 18 for collecting measuring data which forwards the measuring data recorded with the aid of the microphones 13 to a computer 19 running evaluation software for a spatial sound field transformation. The control device is also connected to the computer 19.

The sound pressure is measured parallel to the test object surface at discrete points in a two-dimensional plane with the aid of the microphone bank 14 or the microphone array, respectively. The cross spectrum method or the STSF-analysis respectively requires at least one reference signal. FIG. 3 shows three reference microphones 20. The reference signal serves for assigning the sound pressure recorded by means of the microphones 13 to a certain test object with the aid of a coherence analysis. Consequently, it is possible to filter out non-coherent sound. The spatial sound field transformation therefore is not affected by acoustic sources of interference. Acoustic quantities, particularly the sound pressure, may be used as the reference signal.

The realization of the invention is not restricted to the above-described embodiment. On the contrary, it would be conceivable to realize numerous variations that have a fundamentally different design, but also utilize the object of the invention disclosed in the claims. The device according to the invention, in particular, may comprise only a single microphone that can be moved into different measuring positions. Within the scope of the invention, the term microphone also refers to a sound intensity probe.

1. A device for measuring the sound insulation or insertion insulation of a test object, particularly a passenger compartment section of a motor vehicle, wherein said device comprises at least one source of sound for generating a sound field, at least one microphone or one sound intensity probe and a device for recording acoustic measuring data, characterized in that the source of sound is formed by a single, portable loudspeaker or compression driver (1) that is provided with an adapter (3) containing a plurality of sound openings (7) with flexible tubes (8.1, 8.2, 8.3, 8.n) connected thereto, wherein the open ends (9) of the tubes (8.1, 8.2, 8.3, 8.n) define a plurality of separate discrete sources of sound.

2. The device according to claim 1, characterized in that at least four tubes (8.1, 8.2, 8.3, 8.n) are connected to the adapter (3), wherein the open ends (9) of said tubes define separate punctiform sources of sound.

3. The device according to claim 1 or 2, characterized in that at least one of the tubes (8.1, 8.2, 8.3, 8.n) is realized in such a way with respect to its material and/or its structure that its surface acts in a sound-radiating fashion during the operation of the source of sound.

4. The device according to claim 1 or 2, characterized in that at least one of the tubes (8.1, 8.2, 8.3, 8.n) is provided with a sound-insulating and/or sound-deadening cover.

5. The device according to one of claims 1-4, characterized in that the tubes (8.1, 8.2, 8.3, 8.n) are detachably connected to the sound openings of the adapter.

6. The device according to one of claims 1-5, characterized in that the adapter (3) is realized in the form of a capsule (4) that can be connected to the loudspeaker or compression driver (1).

7. The device according to claim 6, characterized in that the capsule (4) is realized in a dome-shaped, hemispherical or oval fashion.

8. The device according to one of claims 1-7, characterized in that the tubes (8.1, 8.2, 8.3, 8.n) consist of tubes that can be bent in a dimensionally stable fashion.

9. The device according to one of claims 1-8, characterized in that the tubes (8.1, 8.2, 8.3, 8.n) respectively contain an integrated wire spiral (10).

10. The device according to one of claims 1-9, wherein said device additionally comprises a microphone bank (14) that is composed of several microphones (13) arranged along a line or a microphone array that is composed of several microphones arranged in a grid.

11. The device according to one of claims 1-10, characterized in that the microphone, the microphone bank (14) or the microphone array is displaceably mounted on a holding arrangement (15).

12. The device according to claim 10 or 11, characterized in that the microphone bank (14) or the microphone array is connected to a device (18) for collecting measuring data which forwards the measuring data to a computer (19) running evaluation software for a spatial sound field transformation.
